(19) United States
(12) Patent Application Publication
(10) Pub. No.: US 2008/0241018 A1
(43) Pub. Date: Oct. 2, 2008

(54) Nanocarbon generating equipment

(75) Inventors: Eiichi Sugiyama, Yokohama-shi (JP); Kazutaka Kojo, Yokohama-shi (JP); Tadashi Imai, Yokohama-shi (JP); Tsuyoshi Noma, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA.

(21) Appl. No.: 11/902,289

(22) Filed: Sep. 20, 2007

(30) Foreign Application Priority Data
Oct. 16, 2006 (JP) 2006-281864

(51) Int. Cl. B01J 19/00

(52) U.S. Cl. 422/187

(57) ABSTRACT

There is disclosed a nanocarbon generating equipment which is designed to execute a process wherein an organic processed material is thermally decomposed at first and then the decomposed matter is cooled and liquefied. The apparatus comprising a thermal reactor for thermally decomposing the organic processed material, a recovering device which is configured to cool and liquefy a decomposed organic processed material and to recover a liquefied product, and a high-temperature furnace for treating the liquefied product, wherein impurities contained in the liquefied product is removed and the resultant liquefied product is introduced into the high-temperature furnace kept in a reducing atmosphere to generate nanocarbon through a vapor-phase growth.

### CROSS-REFERENCE TO RELATED APPLICATIONS

This application is based upon and claims the benefit of priority from prior Japanese Patent Application No. 2006-281864, filed Oct. 16, 2006, the entire contents of which are incorporated herein by reference.

### BACKGROUND OF THE INVENTION

1. Field of the Invention

This invention relates to nanocarbon generating equipment which is designed such that a thermally decomposable organic processed material, such as biomass, waste, etc., is thermally decomposed at first and then the decomposed matter is cooled and liquefied to obtain nanocarbon.

2. Description of the Related Art

In recent years, in view of coping with various problems such as environmental problems, energy problems and resource securing problems, various techniques have been developed wherein various kinds of wastes such as industrial wastes are appropriately treated to thereby extract energy or useful materials from the wastes without releasing environmental pollutants to the atmosphere, thus effectively utilize the wastes. Waste disposal technique of this kind is known for example in JP-A 11-61158 (KOKAI).

Namely, this patent publication discloses a process which comprises the steps of: melting plastics in a thermal decomposition tank to obtain plastics in a molten state; subjecting the molten plastics to liquid-phase contact with a primary catalytic layer consisting of activated carbon to thereby thermally decompose the plastics to generate pyrolysis gas; and subjecting the pyrolysis gas to vapor-phase contact with a secondary catalytic layer of the secondary catalyst column which is disposed to communicate with an upper inner portion of the thermal decomposition tank, thereby producing a hydrocarbon gas of low molecular weight as a softened state.

In this conventional waste disposal technique for organic processed material however, since the waste is subjected to batch treatment in a high-temperature furnace, it takes a long time to accomplish the procedures wherein a catalyst is introduced into the furnace at first and, upon finishing the reaction, the furnace is cooled and the carbon thus produced is taken out of the furnace. Further, there is a problem that when the carbon is taken out of the furnace before the carbon is sufficiently cooled, there are possibilities that the carbon may be caused to burn. Further, there are problems that since the reaction takes place in a reducing atmosphere, it may become difficult to maintain the reducing atmosphere if the apparatus is large in scale and, at the same time, the loading of catalyst as well as continuous withdrawal of produced carbon may become difficult.

### BRIEF SUMMARY OF THE INVENTION

An object of the present invention is to provide a nanocarbon generating equipment which makes it possible to perform the withdrawal of produced carbon within a short time and more safely as compared with the prior art and also makes it possible to easily perform the loading of catalyst and continuous withdrawal of produced carbon even if the apparatus is increased in scale.

According to the present invention, there is provided a nanocarbon generating equipment which is designed to execute a process wherein an organic processed material is thermally decomposed at first and then the decomposed matter is cooled and liquefied; the apparatus comprising: a thermal reactor for thermally decomposing the organic processed material; a recovering device which is configured to cool and liquefy a decomposed organic processed material and to recover a liquefied product; and a high-temperature furnace for treating the liquefied product; wherein impurities contained in the liquefied product is removed and the resultant liquefied product is introduced into the high-temperature furnace kept in a reducing atmosphere to generate nanocarbon through a vapor-phase growth.

### BRIEF DESCRIPTION OF THE SEVERAL VIEWS OF THE DRAWING

FIG. 1 is a flowchart illustrating the process of the nanocarbon generating equipment according to a first embodiment;

FIG. 2 is a flowchart illustrating the process of the nanocarbon generating equipment according to a second embodiment;

FIG. 3 is a diagram illustrating the combination of the thermal reactor and the CVD apparatus in the nanocarbon generating equipment according to a third embodiment;

FIG. 4 is a diagram illustrating an integrated structure of the thermal reactor and the CVD apparatus in the nanocarbon generating equipment according to a fourth embodiment;

FIG. 5 is a diagram illustrating a vertical CVD apparatus in the nanocarbon generating equipment according to a fifth embodiment; and

FIG. 6 is a diagram illustrating a modified structure of the vertical CVD apparatus shown in FIG. 5.

### DETAILED DESCRIPTION OF THE INVENTION

Next, the nanocarbon generating equipment according to the present invention will be explained further in detail as follows.

(1) As described above, the nanocarbon generating equipment according to the present invention (a first invention) is featured in that it is designed to execute a process wherein an organic processed material is thermally decomposed at first and then the decomposed matter is cooled and liquefied. This apparatus comprises a thermal reactor for thermally decomposing the organic processed material; a recovering device which is configured to cool and liquefy a decomposed organic processed material and to recover a liquefied product; and a high-temperature furnace for treating the liquefied product; wherein impurities contained in the liquefied product is removed and the resultant liquefied product is introduced into the high-temperature furnace kept in a reducing atmosphere, thereby allowing nanocarbon to generate through a vapor-phase growth.

According to the first invention as described above, it is possible to perform the withdrawal of produced carbon within a short time and more safely as compared with the prior art. Further, it is also possible to easily perform the loading of catalyst and continuous withdrawal of produced carbon even if the scale of the process is increased. By the way, it is preferable, in the aforementioned structure (1), to quickly perform the thermal decomposition of organic processed material and then to quench and liquefy the decomposed products. In this case, the expression “quickly” means a period of not more than about 5-6 seconds, thus distinguishing it from the ordinary thermal decomposition in the speed of thermal decomposition. This quick thermal decomposition is effective in recovering a large quantity of liquefied product. For example, it has been made clear that when ratio of the liquefied product to the entire products (a total of the gaseous product and the liquefied product) is expressed on the ordinate abscissa and the reaction time is expressed on the abscissa in a graph, the ratio decreases in proportion to the lapse of time. Therefore, if the recovery ratio of the liquefied product is desired to be enhanced, it is more effective to accomplish the thermal decomposition as quickly as possible.

(2) A second invention is characterized in that, in contrast to the first invention, the recovering device is not required to be employed, so that the thermally decomposed gas obtained through the thermal decomposition of an organic processed material in the thermal reactor is directly charged into the high-temperature furnace.

More specifically, the second invention is directed to a nanocarbon generating equipment comprising: a thermal reactor for thermally decomposing an organic processed material; and a high-temperature furnace; wherein the high-temperature furnace is designed to be directly loaded with a thermally decomposed gas to be derived from the organic processed material which has been thermally decomposed in the thermal reactor, and the liquefied product loaded in the high-temperature furnace kept in a reducing atmosphere is treated in a manner to generate nanocarbon through a vapor-phase growth.

Namely, this second invention is applicable to the case where the thermally decomposed gas contains no or substantially no impurities. When a catalyst is placed in the high-temperature furnace constructed as described above, the thermally decomposed gas is enabled to contact the catalyst, thereby making is possible to generate nanocarbon.

(3) The high-temperature furnace in the aforementioned inventions (1) and (2) may be formed of an external heating kiln which is designed to thermally decompose an organic processed material. This external heating kiln may be configured such that it is provided therein with a scraper ball formed of sintered catalyst. When the high-temperature furnace is constructed in this manner, nanocarbon (high-functional carbon) can be obtained without necessitating the introduction of a catalyst into the high-temperature furnace. However, this scraper ball may be disposed inside the kiln separately from the catalyst.

(4) The high-temperature furnace in the aforementioned inventions (1) and (2) may be provided with mechanisms to perform the introduction of a catalyst as well as the withdrawal of produced nanocarbon and the catalyst. When the high-temperature furnace is constructed in this manner, the introduction of a catalyst as well as the withdrawal of produced nanocarbon and the catalyst can be performed continuously.

(5) The high-temperature furnace in the aforementioned inventions (1) to (4) may be provided, on a downstream side thereof, with a cooling mechanism. When the high-temperature furnace is constructed in this manner, the thermally decomposed gas obtained through a rapid thermal decomposition process can be cooled and liquefied, thus making it possible to recover the liquefied product.

### EXAMPLES

Next, specific examples of the nanocarbon generating equipment according to the present invention will be explained with reference to drawings.

### First Embodiment

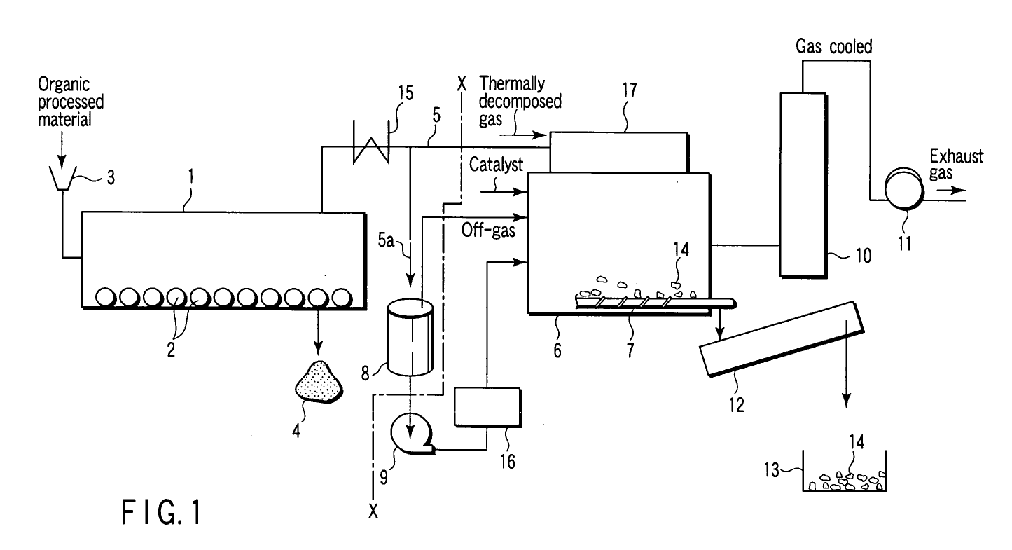

FIG. 1 is a flowchart illustrating the process of the nanocarbon generating equipment according to a first embodiment.

The thermal reactor 1 is capable of executing quick thermal decomposition of an organic processed material at a temperature ranging from 400 to 700° C. A large number of scraper balls 2 are arranged in the thermal reactor 1. The organic processed material can be introduced into the thermal reactor 1 through a hopper 3. A carbide 4 to be produced from the quick thermal decomposition can be withdrawn from the bottom of the thermal reactor 1 and a thermally decomposed gas can be discharged via a piping 5 from an upper portion of the thermal reactor 1.

A cooling section 15 is disposed at a midway of the piping 5, thereby enabling the thermally decomposed gas created from the quick thermal decomposition process to be directly cooled, condensed and liquefied. As a result, a liquefied product 5a thus obtained is delivered, via a liquefied material recovering tank 8 and a pump 9, to a filter 16 to perform the filtration of the liquefied product 5a. A recovering apparatus is constituted by the cooling section 15 and the liquefied material recovering tank 8.

The filtrate from which impurities are filtered off can be delivered to a high-temperature furnace 6 which is kept in a reducing atmosphere. The liquefied product 5a thus recovered is transferred to pass through the filter 16 to remove impurities and recovered as a filtrate and delivered to the high-temperature furnace 6. Off-gas is delivered to the high-temperature furnace 6 from an upper portion of the liquefied material recovering tank 8. The reason for delivering the off-gas to the high-temperature furnace 6 is to enhance the efficiency of producing carbon nanotube. Namely, it is possible to enhance the efficiency of producing carbon nanotube by injecting off-gas into the high-temperature furnace 6 in a step of generating carbon nanotube from the liquefied product. A catalyst (for example, a Mo/Ni/MgO particulate catalyst) is also delivered to the high-temperature furnace 6.

A nanocarbon-discharging screw 7 for delivering the formed nanocarbon 14 toward the sidewall (right hand in FIG. 1) of the high-temperature furnace 6 is disposed at a bottom portion of the high-temperature furnace 6. Further, a heater (not shown) is arranged in the interior of high-temperature furnace 6. By means of this heater, the interior of the high-temperature furnace 6 is heated to about 1100° C. to thereby generate nanocarbon 14 by way of vapor-phase growth. By the way, part of the thermally decomposed gas is employed as a fuel for a burner of a heating chamber 17 provided at an upper portion of the high-temperature furnace 6 and hence this part of the thermally decomposed gas is delivered to the burner.

The nanocarbon 14 discharged by means of the nanocarbon-discharging screw 7 from the bottom of high-temperature furnace 6 is delivered to a nanocarbon cooler 12 which is obliquely disposed below the high-temperature furnace 6. The nanocarbon cooler 12 is provided therein with a carbon carrier screw (not shown), thereby enabling the nanocarbon 14 that has been cooled to be transferred from the left hand to the right hand in FIG. 1. The nanocarbon 14 is recovered in a nanocarbon-recovering vessel 13. Further, the gas in the high-temperature furnace 6 is cooled by means of a gas cooler 10 and discharged through a suction blower 11.

The thermal reactor 1, the cooling section 15, the liquefied material recovering tank 8, the pump 9, the filter 16, the high-temperature furnace 6, the gas cooler 10 and the nanocarbon cooler 12 are all installed within the same location.

According to the first embodiment, due to the provision of the nanocarbon-discharging screw 7 disposed at the bottom of high-temperature furnace 6 and also due to the provision of the nanocarbon cooler 12, the withdrawal of nanocarbon 14 can be executed within a shorter period of time as compared with the conventional carbon generating apparatus and safely without causing the burning of nanocarbon 14. Further, even if the nanocarbon generating equipment is increased in scale, the loading of catalyst and the withdrawal of nanocarbon 14 formed can be continuously performed.

By the way, although this first embodiment is directed to the case where the thermal reactor 1 is of horizontal type, the thermal reactor 1 may be of vertical type. Further, although this first embodiment is directed to the case where the thermal reactor 1, the cooling section 15, the liquefied material recovering tank 8, the pump 9, the filter 16 and the high-temperature furnace 6 are all installed within the same location, they may be separated into two parts as shown by a dot and dash line X-X in FIG. 1, i.e., one group of apparatuses to be employed for executing the steps including the thermal decomposition and the recovery of liquefied product before the pump 9 (left hand of the dot and dash line X-X); and the other group of apparatuses to be employed for executing the steps for ultimately generating the nanocarbon (right hand of the dot and dash line X-X), which are to be followed subsequent to those of said one group. By separately installing these apparatuses in this manner, it is possible to perform the thermal decomposition and the recovery of liquefied product separately from the generation of nanocarbon even if the space available for these apparatuses is limited.

### Second Embodiment

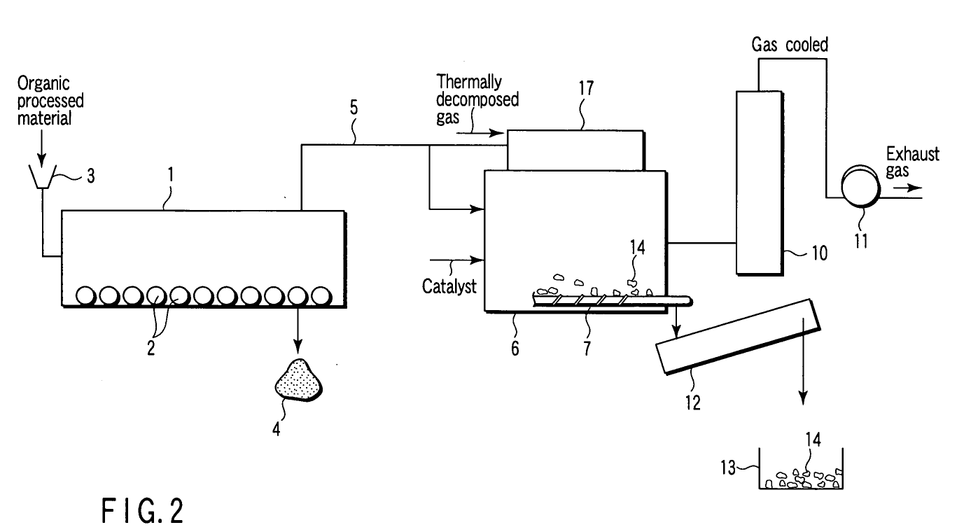

FIG. 2 is a flowchart illustrating the process of the nanocarbon generating equipment according to a second embodiment. In FIG. 2, the same components as those of FIG. 1 are identified by the same symbols, thereby omitting the explanation thereof.

In the second embodiment, the thermally decomposed gas that has been derived from the thermal decomposition process in the thermal reactor 1 is directly introduced into the high-temperature furnace 6. Further, in the second embodiment, the thermal reactor 1 is enabled to be heated by making use of the exhaust gas discharged from the high-temperature furnace 6.

If impurities are not included in the organic processed material to be treated, it is possible to recover nanocarbon as it is. According to the second embodiment, it is possible to obtain almost the same effects as in the case of the first embodiment and, at the same time, to simplify the construction of the equipment.

### Third Embodiment

FIG. 3 is a diagram illustrating the combination of the thermal reactor and the CVD apparatus in the nanocarbon generating equipment according to a third embodiment. In FIG. 3, the same components as those of FIG. 1 are identified by the same symbols, thereby omitting the explanation thereof.

The reference number 21 shown in FIG. 3 represents a thermal reactor of horizontal external heat kiln type. An inner tube (not shown) for sustaining the processed material in the thermal reactor 21 is enabled to rotate as shown by an arrow “A” and contains a large number of scraper balls 2 which are arranged in the inner tube. The interior of this inner tube of the thermal reactor 21 is designed to be heated up to 400-500° C. The organic processed material that has been introduced into the thermal reactor 21 is thermally decomposed, producing carbide which is subsequently recovered from the bottom of thermal reactor. The thermal reactor 21 is designed such that the interior of the inner tube thereof is heated up to 700-1000° C. and it is connected with the CVD apparatus 22 which is of horizontal external heat kiln type and enabled to rotate as shown by an arrow “A” as in the case of the thermal reactor 21.

A plurality of catalytic balls 23 acting also as a scraper are arranged at the bottom of the CVD apparatus 22. As these catalytic balls 23 are made to contact each other, nanocarbon (high-functional carbon) is caused to peel away from these catalytic balls 23 and permitted to accumulate on the bottom of CVD apparatus 22. Exhaust gas is discharged from an upper portion of the CVD apparatus 22 and the high-functional carbon 24 thus produced is recovered from the bottom of CVD apparatus 22.

According to the third embodiment, it is possible to obtain almost the same effects as in the case of the first embodiment. Further, since the catalytic balls 23 acting also as a scraper are arranged at the bottom of the CVD apparatus 22, it is possible to obtain the high-functional carbon without necessitating the introduction of a catalyst into the thermal reactor 21.

By the way, although this third embodiment is directed to the case where the CVD apparatus 22 is of the horizontal external heat kiln type, the CVD apparatus 22 may be of the vertical type. Although these catalytic balls 23 are provided with catalytic action, they are gradually scraped away to become smaller. Therefore, the catalyst may be additionally introduced into the CVD apparatus 22.

### Fourth Embodiment

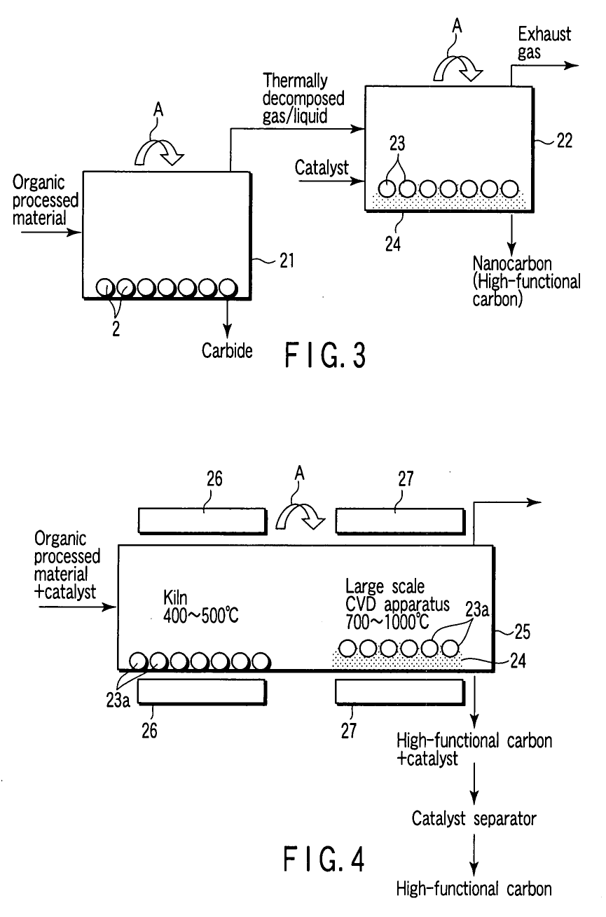

FIG. 4 is a diagram illustrating an integrated structure of the thermal reactor and the CVD apparatus in the nanocarbon generating equipment according to a fourth embodiment.

The reference number 25 shown in FIG. 4 represents a thermal reactor/CVD integrated apparatus which is capable of forming nanocarbon by means of CVD method. On the upstream side (left hand in FIG. 4) of this thermal reactor/CVD integrated apparatus 25, there are disposed a large number of scraper balls 23a each having catalytic action. The interior of the inner tube is designed to be heated up to 400-500° C. by means of a first heating section 26. On the downstream side (right hand in FIG. 4) of this thermal reactor/CVD integrated apparatus 25, there are disposed a large number of scraper balls 23a each having catalytic action. The interior of the inner tube is designed to be heated up to 700-1000° C. by means of a second heating section 27. The thermal reactor/CVD integrated apparatus 25 is made rotatable in the direction indicted by an arrow “A”. In the operation of the thermal reactor/CVD integrated apparatus 25, an organic processed material and a catalyst are introduced into the thermal reactor/CVD integrated apparatus 25 so as to thermally decompose the organic processed material. In a region located on the second heating section 27, these catalytic balls 23b are made to contact each other, thereby causing high-functional carbon to peel away from the surfaces of these catalytic balls 23 and permitting the high-functional carbon 24 to accumulate on the bottom of thermal reactor/CVD integrated apparatus 25. Meanwhile the thermally decomposed gas is permitted to discharge from an upper portion of the thermal reactor/CVD integrated apparatus 25 and the high-functional carbon 24 thus produced is discharged together with the catalyst from the bottom of thermal reactor/CVD integrated apparatus 25. Thereafter, the high-functional carbon 24 and the catalyst are sent to a catalyst separator to recover only the high-functional carbon 24.

According to this fourth embodiment, it is possible to realize a nanocarbon generating equipment which is simpler in structure as compared with the equipment of the first embodiment. By the way, in the explanation of the embodiment shown in FIG. 4, although the catalyst is introduced, together with an organic processed material, into the thermal reactor/CVD integrated apparatus 25. However, since mill balls 23a and 23b which are capable of acting also as a catalyst are disposed therein, the catalyst may not necessarily be introduced into the thermal reactor/CVD integrated apparatus 25.

By the way, although this fourth embodiment is directed to the case where the thermal reactor/CVD integrated apparatus 25 is of horizontal type, the thermal reactor/CVD integrated apparatus 25 may be of vertical type.

### Fifth Embodiment

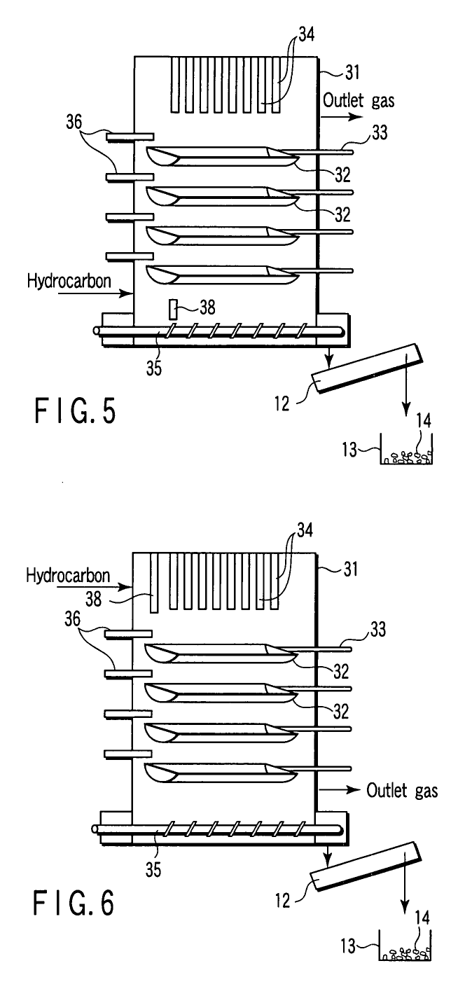

FIG. 5 is a diagram illustrating the structure of vertical CVD apparatus in the nanocarbon generating equipment according to a fifth embodiment. In FIG. 5, the same components as those of FIG. 1 are identified by the same symbols, thereby omitting the explanation thereof.

The reference number 31 shown in FIG. 5 represents a vertical CVD apparatus the interior of which can be made into a reducing atmosphere. A plurality of catalyst-retaining vessels 32 are disposed inside the vertical CVD apparatus. These catalyst-retaining vessels 32 are respectively rotatably supported by a supporting rod 33. A plurality of heaters 34 for heating the interior of the CVD apparatus up to about 1100° C. are disposed at an upper portion of the vertical CVD apparatus 31. A nanocarbon-discharging screw 35 is disposed at the bottom of vertical CVD apparatus 31. By means of this screw 35, the nanocarbon that has been produced is transferred from left to right in the drawing. A plurality of nozzles 36 for introducing a catalyst into the catalyst-retaining vessels 32 are attached to the sidewall of vertical CVD apparatus 31.

A straightening vane 38 is disposed near the bottom of vertical CVD apparatus 31, so that the thermally decomposed gas (hydrocarbon gas) that has been introduced into the CVD apparatus is enabled to be effectively made to contact a catalyst. The nanocarbon 14 produced through the thermal decomposition process in the vertical CVD apparatus 31 is delivered to a carbon cooler 12 which is obliquely disposed bellow the vertical CVD apparatus 31. The carbon cooler 12 is provided therein with a carbon-feeding screw (not shown), thereby enabling the nanocarbon 14 that has been cooled to be delivered from left to right in the drawing. Ultimately, the nanocarbon 14 is recovered in a nanocarbon recovery vessel 13.

In this vertical CVD apparatus 31 that has been constructed as described above, when hydrocarbon gas is introduced into the vertical CVD apparatus 31 that has been kept in a reducing atmosphere, the hydrocarbon gas is enabled to contact the catalyst disposed in the CVD apparatus 31, thereby generating nanocarbon. The nanocarbon 14 that has been generated in this manner is delivered, by means of the nanocarbon-discharging screw 35, to the outside of vertical CVD apparatus 31 through a bottom portion thereof and then recovered after being cooled by means of the carbon cooler 12. The catalyst is introduced, through a nozzle 36, into a catalyst container 32 and, after the use thereof for a predetermined period, the catalyst container 32 is turned upside down, thereby dropping the catalyst as well as the carbon produced down to the bottom of the CVD apparatus. These operations are executed while maintaining the high temperature and the reducing atmosphere.

According to the fifth embodiment, it is possible to obtain almost the same effects as obtained in the first embodiment. Further, the introduction of a catalyst as well as the withdrawal of produced nanocarbon and the catalyst can be performed continuously. By the way, although this fifth embodiment is directed to the case where the interior of the CVD apparatus is heated by making use of a heater, it may be heated by making use of a heating source such as a burner.

### Sixth Embodiment

FIG. 6 is a diagram illustrating the structure of vertical CVD apparatus in the nanocarbon generating equipment according to a sixth embodiment. In FIG. 6, the same components as those of FIGS. 1 and 5 are identified by the same symbols, thereby omitting the explanation thereof.

This sixth embodiment is a modified embodiment of the vertical CVD apparatus shown in FIG. 5. This embodiment is featured in that hydrocarbon gas is introduced into the vertical CVD apparatus 31 from an upper portion thereof and that the straightening vane 38 is disposed at an upper portion of the furnace (vertical CVD apparatus 31). According to the sixth embodiment, it is possible to obtain almost the same effects as obtained in the fifth embodiment. By the way, in this sixth embodiment also, a burner may be substituted for the heater as a heating source.

What is claimed is:

1. A nanocarbon generating equipment which is designed to execute a process wherein an organic processed material is thermally decomposed at first and then the decomposed matter is cooled and liquefied; the apparatus comprising:
a thermal reactor for thermally decomposing the organic processed material;
a recovering device which is configured to cool and liquefy a decomposed organic processed material and to recover a liquefied product; and
a high-temperature furnace for treating the liquefied product;
wherein impurities contained in the liquefied product is removed and the resultant liquefied product is introduced into the high-temperature furnace kept in a reducing atmosphere to generate nanocarbon through a vapor-phase growth.

2. A nanocarbon generating equipment comprising:
a thermal reactor for thermally decomposing an organic processed material; and
a high-temperature furnace;
wherein the high-temperature furnace is designed to be directly loaded with a thermally decomposed gas to be derived from the organic processed material which has been thermally decomposed in the thermal reactor, and the liquefied product loaded in the high-temperature furnace kept in a reducing atmosphere is treated in a manner to generate nanocarbon through a vapor-phase growth.

3. The apparatus according to claim 1, wherein the high-temperature furnace is an external heating kiln which is capable of thermally decomposing an organic processed material and provided therein with a scraper ball formed of sintered catalyst.

4. The apparatus according to claim 2, wherein the high-temperature furnace is an external heating kiln which is capable of thermally decomposing an organic processed material and provided therein with a scraper ball formed of sintered catalyst.

5. The apparatus according to claim 1, wherein the high-temperature furnace is provided with mechanisms to perform the introduction of a catalyst, and the withdrawal of produced nanocarbon and the catalyst.

6. The apparatus according to claim 2, wherein the high-temperature furnace is provided with mechanisms to perform the introduction of a catalyst, and the withdrawal of produced nanocarbon and the catalyst.

7. The apparatus according to claim 1 or 2, wherein the high-temperature furnace is provided, on a downstream side thereof, with a cooling mechanism.

8. The apparatus according to claim 3 or 4, wherein the high-temperature furnace is provided, on a downstream side thereof, with a cooling mechanism.

9. The apparatus according to claim 5 or 6, wherein the high-temperature furnace is provided, on a downstream side thereof, with a cooling mechanism.
